(19) United States
(12) Patent Application Publication
(10) Pub. No.: US 2008/0201300 A1
(43) Pub. Date: Aug. 21, 2008

(54) METHOD AND SYSTEM FOR STORING AND ACCESSING LARGE SCALE ONTOLOGIES USING A RELATIONAL DATABASE

(75) Inventors: Richard T. Goodwin, Dobbs Ferry, NY (US); Juhnyoung Lee, Yorktown Heights, NY (US); George A. Mihaila, Yorktown Heights, NY (US); Ioana R. Stanoi, San Jose, CA (US)

Correspondence Address: CANTOR COLBURN LLP-IBM YORKTOWN, 20 Church Street, 22nd Floor, Hartford, CT, 06103, US

(73) Assignee: International Business Machines Corporation, Armonk, NY (US)

(21) Appl. No.: 11/675,234

(22) Filed: Feb. 15, 2007

(51) Int. Cl. G06F 17/30

(52) U.S. Cl. 707/3

(57) ABSTRACT

A method for providing ontology management that leaves existing instance data stored in a relational database, while virtualizing the existing instance data for accesses originating from an ontology application, wherein the method includes: submitting an ontology application query to an ontology management system; rewriting the ontology application query with a mapping module into a vertical format mapped query; submitting the vertical format mapped query and view definitions to a database query processor; retrieving relevant existing instance data from the relational database in response to request from the database query processor; and virtualizing the retrieved relevant existing instance data for use by the ontology application.

### TRADEMARKS

IBM® is a registered trademark of International Business Machines Corporation, Armonk, N.Y., U.S.A. Other names used herein may be registered trademarks, trademarks or product names of International Business Machines Corporation or other compares.

### BACKGROUND OF THE INVENTION

1. Field of the Invention

This invention relates generally to ontology management, and more particularly to systems and methods for providing architectures for ontology management that leaves the existing data in place, while virtualizing the existing data for the accesses originating from an ontology application.

2. Description of the Related Art

An ontology is similar to a dictionary or glossary, but with greater detail and structure that enables computers to process its content. The ontology consists of a set of concepts, axioms, and relations, and represents an area of knowledge. Ontologies are often specified in a declarative form by using semantic markup languages such as Resource Description Framework (RDF) and Web Ontology Language (OWL). Ontologies provide a number of potential benefits in processing knowledge, including the externalization of domain knowledge from operational knowledge, sharing of common understanding of subjects among human and also among computer programs, and the reuse of domain knowledge. Ontologies are also very useful in information integration tasks.

Currently, ontology management systems are either memory-based or use ad-hoc solutions for persisting data. While this is adequate for dealing with the class hierarchies in small to medium-size ontologies, it does not scale for applications that involve large amounts of instance data. This is due to the emphasis that is placed on the metadata (hierarchy of classes or concepts) as first-class citizen as opposed to the data (instances of classes). However, many new application domains, for example life sciences, deal with large amounts of pre-existing data that require linking to the ontology. Existing solutions recommend migrating existing data into the ontology data structures. However, if other applications still use that data, this approach requires constant replication to keep the two versions in sync. Moreover, typical ad-hoc storage solutions do not provide the same level of support for data integrity, concurrent access, and recovery as a mature database management system.

Stored ontology tuples (records) correspond to two kinds of facts: assertions about properties and relationships of classes, and information about instances of these classes. Organizing tuples in this manner is a very natural and flexible solution for storing an ontology since it is straightforward to update, and extend with new classes and queries. However, this solution does not scale very well for a number of reasons. First, queries that reconstruct instance objects involve costly self-joins of the fact table. This can be overcome by splitting the storage into several tables, one for each class, at the cost of losing the flexibility of representing all facts in a uniform way. Second, as the fact table becomes very large with many instances, the overall performances of queries and inference triggers will be affected. Third, if existing data is to be integrated with the ontology, this solution requires that the existing data be migrated into facts that can be stored in the fact table. However, this needs to be done in such a way as to not disrupt existing applications that interact with that database. This essentially means that there is a need to create a replica of the instance data in the fact table. As the underlying data changes, the fact table needs to be continuously synchronized with it. In fact, updates may need to be propagated both ways, if the ontology applications are allowed to modify instance data.

### SUMMARY OF THE INVENTION

Embodiments of the invention provide a method for ontology management that leaves existing instance data stored in a relational database, while virtualizing the existing instance data for accesses originating from an ontology application, wherein the method includes: submitting an ontology application query to an ontology management system; rewriting the ontology application query with a mapping module into a vertical format mapped query; submitting the vertical format mapped query and view definitions to a database query processor; retrieving relevant existing instance data from the relational database in response to request from the database query processor; and virtualizing the retrieved relevant existing instance data for use by the ontology application.

A system for providing ontology management, the system includes; computing devices; communication devices; information appliances; a network; wherein the computing devices further comprise at least one of the following: computer servers; mainframe computers; desktop computers; and mobile computing devices; wherein at least one of the computing devices, communication devices, and information appliances is configured to execute electronic software that manages the ontologies; wherein the electronic software is resident on a storage medium in signal communication with at least one of the computing devices, communication devices, and information appliances; wherein the electronic software leaves existing instance data stored in a relational database, while virtualizing the existing instance data for accesses originating from an ontology application and wherein at least one of the computing devices, communication devices, and information appliances is in signal communication with the network; and wherein the network further comprises at least one of the following: a local area network (LAN); a wide area network (WAN); a global network; an Internet; an intranet; wireless networks; and cellular networks.

An article comprising machine-readable storage media containing instructions that when executed by a processor enable the processor to provide ontology management that leaves existing instance data stored in a relational database, while virtualizing the existing instance data for accesses originating from an ontology application, wherein the instructions include: submitting an ontology application query to an ontology management system; rewriting the ontology application query with a mapping module into a vertical format mapped query; submitting the vertical format mapped query and view definitions to a database query processor; retrieving relevant existing instance data from the relational database in response to request from the database query processor; and virtualizing the retrieved relevant existing instance data for use by the ontology application.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, a solution is technically achieved for a system and method for providing architectures for ontology management that leave the existing data in place, while virtualizing the existing data for the accesses originating from an ontology application. The architecture assumes that existing data (instance data) is stored in a relational database, and metadata virtualizes the instance data in the format of the fact table understood by the ontology. An interface provides access to the classes and instances of the ontology in a transparent manner. The architecture has the advantage of isolating the ontology applications from the complexity of the distributed storage space and schemas.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a three-layered architecture for ontology data management according to an embodiment of the invention.

FIG. 2 illustrates an ontology application posing queries over a virtual vertical table according to an embodiment of the invention.

FIG. 3 illustrates a system for implementing ontology data management according to an embodiment of the invention.

The detailed description explains the preferred embodiments of the invention, together with advantages and features, by way of example with reference to the drawings.

### DETAILED DESCRIPTION OF SPECIFIC EMBODIMENTS

Embodiments of the present invention provide a system and method for architectures for ontology management that leave the existing data in place, while virtualizing it for the accesses originating from an ontology application. The architecture assumes that existing data (instance data) is stored in a relational database, and metadata virtualizes the instance data in the format of the fact table understood by the ontology. An interface provides access to the classes and instances of the ontology in a transparent manner. The architecture has the advantage of isolating the ontology applications from the complexity of the distributed storage space and schemas.

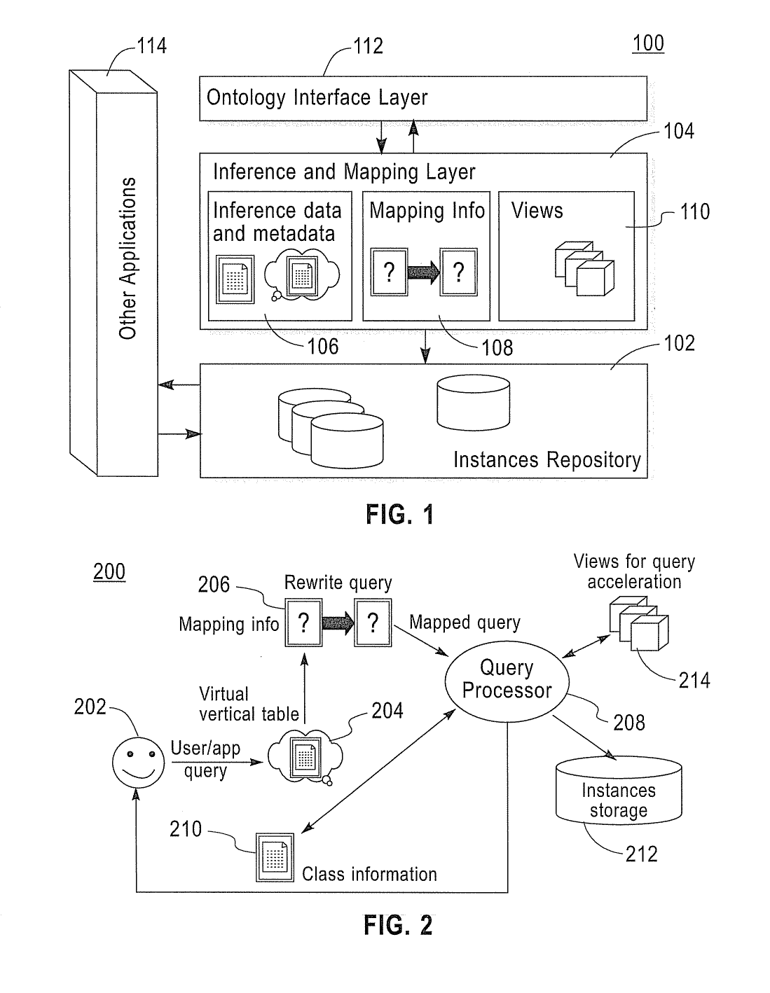

FIG. 1 illustrates architecture 100 of an ontology management system according to an embodiment of the invention. The architecture 100 assumes that existing data (instances data) is stored in a relational database called the instances repository 102 (the bottom layer in the figure). The middle layer called the inference and mapping layer 104 deals with metadata necessary for the virtualization of the instance data in the format of the fact table understood by the ontology, and has inference data and metadata 106, mapping information 108, and views 110. The top layer is referred to as the ontology interface layer 112 and acts as an interface providing access to the classes and instances of the ontology in a transparent manner. This architecture has the advantage that it isolates the ontology applications from the complexity of the distributed storage space and schemas. A block 114 represents other applications that require access to the relational database besides the ontological application.

The inference and mapping layer 104 is able to store ontology-specific metadata 106 (such as classes and relationships between classes) as well a mapping 108 between the virtual view 110 and the schema of the data in the instances repository 102. The information in the inference and mapping layer 104 is used to ensure transparent access to all the different kinds of data in the relational database 102. The transparent access is achieved by rewriting the ontology queries over the virtual fact table abstraction, into structured query language (SQL) requests to the underlying databases.

FIG. 2 illustrates a method for use in an ontology management system 200 and its handling of an ontology application/user query 202 over a virtual vertical table 204 according to an embodiment of the invention. The inference and mapping layer 206 rewrites the query 202 using the predefined mapping information into queries over the physical schema. The mapped query proceeds to a database query processor 208 that coordinates the execution of the query, and returns the results back to the application or user in vertical format. It should be noted that the linking between class information 210 and instance storage 212 is transparent to the application or user. The ontology application can therefore operate as before, when dealing with a stored vertical table. Queries over classes and instances are routed trough the mapping module 206 to the query processor 208. Updates and queries from legacy applications (non-ontology) will still operate directly over the instance repository 212. Updates generated by the ontology application will be routed through the mapping module 206 and can modify the metadata as well as the instance repository 212.

Tables 1-3 provide examples to illustrate the different tables used by the ontology, their relationships, and the query and update mechanisms according to an embodiment of the invention.

The virtual vertical table of Table 1 illustrates an ontology that may be found in a university or academic setting. The table contains three types of facts:
Class hierarchy facts describing relationships between classes.
Instance membership facts describing class extents.
Instance facts describing properties of instances (image of the data in the instance repository).

TABLE 1
Virtual Vertical Table

| | | SUBJECT | VERB | OBJECT |
|---|---|---|---|---|
| | | Employee | subClassOf | People |
| | | AcademicStaff | subClassOf | Employee |
| | | Lecturer | subClassQf | AcademicStaff |
| Class | | Researcher | subClassQf | AcademicStaff |
| Hierarchy | {open oversize brace} | | | |
| Facts | | PhDStudent | subClassOf | Researcher |
| | | Student | subClassOf | People |
| | | . . . | . . . | . . . |
| Instance | | 123456 | IsA | PhDStudent |
| Membership | {open oversize brace} | | | |
| Facts | | | | |
| | | 123456 | Name | John Doe |
| Instance Facts | {open oversize brace} | 123456 | DOB | Feb. 03, 1977 |
| | | . . . | . . . | . . . |

The virtual vertical table of Table 1 is in reality an aggregated view of the set of materialized tables stored in the metadata (see Table 2) and instance repositories (see Table 3). For example, the entry (123456, IsA, PhDStudent) in Table 1 is derived using the instance to class mapping for class PhDStudent and the tuple (123456, John Doe, 02-03-1977, PhD) from the STUDENT table in Table 3. The metadata repository (Table 2) contains a materialized class hierarchy table and a set of mappings of instances into classes described declaratively as queries over the instance tables (Table 3). This set of queries, together with the view definition shown in Table 4, provide the query processor complete information about the mapping between the schema of the instance repository and the ontological classes. This avoids storing class membership facts for each instance, thus eliminating the need for constant synchronization.

TABLE 2
Metadata Repository

| | S | V | O |
|---|---|---|---|
| Class Hierarchy | | subClassOf | People |
| Vertical Table | AcademicStaff | subClassOf | Employee |
| | Lecturer | subClassOf | AcademicStaff |
| | Researcher | subClassOf | AcademicStaff |
| | . . . | . . . | . . . |
| | PhDStudent | subClassOf | Researcher |
| | Student | subClassOf | People |
| | . . . | . . . | . . . |

PhDStudent = SELECT SNN FROM STUDENT WHERE Program ram = “PhD”
Lecturer = SELECT SNN FROM EMPLOYEE WHERE JOBTITLE = “Lecturer”

TABLE 3
Instance Repository
Instance to Class
Mappings

| | SSN | NAME | DOB | PROGRAM |
|---|---|---|---|---|
| STUDENT | 123456 | John Doe | Feb. 03, 1977 | PhD |
| | 237659 | Maria Flores | Aug. 11, 1978 | PhD |
| | 859803 | Raj Saran | Dec. 28, 1976 | MS |
| | . . . | . . . | . . . | . . . |

| | SSN | NAME | JOBTITLE |
|---|---|---|---|
| EMPLOYEE | 123456 | John Doe | Researcher |
| | 859803 | Nai Ko | Lecturer |

TABLE 4
Virtual Vertical View Definition

```
CREATE VIEW V AS
  SELECT * FROM C
    UNION
  SELECT SSN AS SUBJECT, ‘IsA’ AS VERB, PhDStudent'
  AS OBJECT FROM STUDENT WHERE PROGRAM = ‘PhD’
    UNION
  SELECTING SSN AS SUBJECT, ‘IsA’ AS VERB, ‘Lecturer’
  AS OBJECT FROM EMPLOYEE WHERE JOBTYTLE = ‘Lecturer’
...
    UNION
  SELECT SSN AS SUBJECT, ‘NAME’ AS VERB, NAME
  AS OBJECT FROM STUDENT
    UNION
  SELECT SSN AS SUBJECT, ‘DOB’ AS VERB, DOB
  AS OBJECT FROM STUDENT
    UNION
  SELECT SSN AS SUBJECT, ‘NAME’ AS VERB, NAME
  AS OBJECT FROM EMPLOYEE
...
```

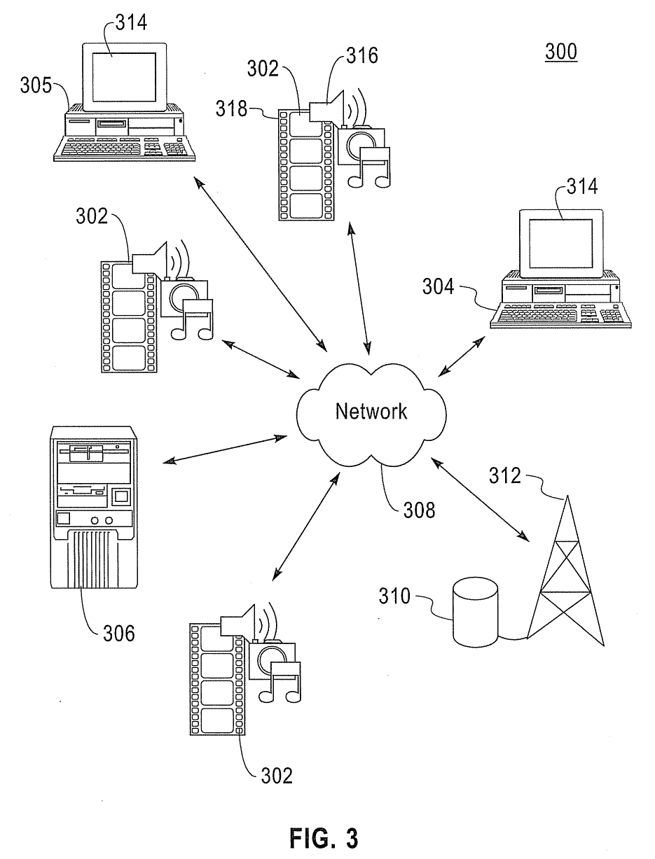

FIG. 3 is a block diagram of an exemplary system 300 for implementing the ontology management of the present invention and graphically illustrates how those blocks interact in operation. The system 300 includes remote devices including one or more multimedia/communication devices 302 equipped with speakers 316 for implementing the audio, as well as display capabilities 318 for facilitating the graphical user interface (GUI) aspects of the present invention. In addition, mobile computing devices 304 and desktop computing devices 305 equipped with displays 314 for use with the GUI of the present invention are also illustrated. The remote devices 302 and 304 may be wirelessly connected to a network 308. The network 308 may be any type of known network including a local area network (LAN), wide area network (WAN), global network (e.g., Internet), intranet, etc. with data/Internet capabilities as represented by server 306. Communication aspects of the network are represented by cellular base station 310 and antenna 312. Each remote device 302 and 304 may be implemented using a general-purpose computer executing a computer program for carrying out the ontological management described herein. The computer program may be resident on a storage medium local to the remote devices 302 and 304, or maybe stored on the server system 306 or cellular base station 310. The server system 306 may belong to a public service. The remote devices 302 and 304, and desktop device 305 may be coupled to the server system 306 through multiple networks (e.g., intranet and Internet) so that not all remote devices 302, 304, and desktop device 305 are coupled to the server system 306 via the same network. The remote devices 302, 304, desktop device 305, and the server system 306 may be connected to the network 308 in a wireless fashion, and network 308 may be a wireless network. In a preferred embodiment, the network 308 is a LAN and each remote device 302, 304 and desktop device 305 executes a user interface application (e.g., web browser) to contact the server system 306 through the network 308. Alternatively, the remote devices 302 and 304 may be implemented using a device programmed primarily for accessing network 308 such as a remote client.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be uiderstood that those skilled in the art, both now and in the future, may make various improvements and enhancements which fall within the scope of the claims which follow. These claims should be construed to maintain the proper protection for the invention first described.

What is claimed is:

1. A method for providing ontology management that leaves existing instance data stored in a relational database, while virtualizing the existing instance data for accesses originating from an ontology application, wherein the method comprises:
submitting an ontology application query to an ontology management system;
rewriting the ontology application query with a mapping module into a vertical format mapped query;
submitting the vertical format mapped query and a series of view definitions to a database query processor;
retrieving relevant existing instance data from the relational database in response to request from the database query processor; and
virtualizing the retrieved relevant existing instance data for use by the ontology application.

2. The method of claim 1, wherein the virtualizing of the retrieved relevant existing instance data involves formatting information in the form of a fact table understood by the ontology application.

3. The method of claim 1, wherein non-ontological applications can access the existing instance data in the relational database.

4. The method of claim 1, wherein the rewriting of the ontology application query is carried out over a virtual fact table abstraction, into a structured query language request to the relational database.

5. A system for providing ontology management, the system comprising:
computing devices;
communication devices;
information appliances;
a network;
wherein the computing devices further comprise at least one of the following:
computer servers;
mainframe computers;
desktop computers; and
mobile computing devices;
wherein at least one of the computing devices, communication devices, and information appliances is configured to execute electronic software that manages the ontologies;
wherein the electronic software is resident on a storage medium in signal communication with at least one of the computing devices, communication devices, and information appliances;
wherein the electronic software leaves existing instance data stored in a relational database, while virtualizing the existing instance data for accesses originating from an ontology application; and
wherein at least one of the computing devices, communication devices, and information appliances is in signal communication with the network; and
wherein the network further comprises at least one of the following:
a local area network (LAN);
a wide area network (WAN);
a global network;
an Internet;
an intranet;
wireless networks; and
cellular networks.

6. The system of claim 5, the ontology management system has an architecture organized in a series of layers comprising:
a bottom layer;
a middle layer; and
a top layer;
wherein the bottom layer is comprised of the relational database with the existing instance data;
wherein the middle layer is comprised of a set of metadata and mapping information for the virtualization of the existing instance data into a format of a fact table understood by the ontology application; and
wherein the third layer acts as an interface providing access to classes and instances of the ontology in a transparent manner, by isolating the ontology applications from the relational database.

7. An article comprising machine-readable storage media containing instructions that when executed by a processor enable the processor to provide ontology management that leaves existing instance data stored in a relational database, while virtualizing the existing instance data for accesses originating from an ontology application, wherein the instructions comprise:
submitting an ontology application query to an ontology management system;
rewriting the ontology application query with a mapping module into a vertical format mapped query;
submitting the vertical format mapped query and view definitions to a database query processor;
retrieving relevant existing instance data from the relational database in response to request from the database query processor; and
virtualizing the retrieved relevant existing instance data for use by the ontology application.

8. The article of claim 1, wherein the virtualizing of the retrieved relevant existing instance data involves formatting information in the form of a fact table understood by the ontology application.

9. The article of claim 1, wherein non-ontological applications can access the existing instance data in the relational database.

10. The article of claim 1, wherein the rewriting of the ontology application query is carried out over a virtual fact table abstraction, into a structured query language request to the relational database.
